(19) United States
(12) Patent Application Publication
(10) Pub. No.: US 2020/0379779 A1
(43) Pub. Date: Dec. 3, 2020

(54) PROGRAM OPERATING METHOD AND APPARATUS, COMPUTING DEVICE, AND STORAGE MEDIUM

(71) Applicant: TENCENT TECHNOLOGY (SHENZHEN) COMPANY LIMITED, Shenzhen (CN)

(72) Inventors: Zhaopeng LIANG, Shenzhen (CN); Shangtao LIANG, Shenzhen (CN); Shun LI, Shenzhen (CN); Xing LIN, Shenzhen (CN); Chao LIN, Shenzhen (CN); Canhui HUANG, Shenzhen (CN); Xuyu GUI, Shenzhen (CN); Haojun HU, Shenzhen (CN); Yihong YANG, Shenzhen (CN); Weibang LUO, Shenzhen (CN); Yaxuan LI, Shenzhen (CN); Zhe CHENG, Shenzhen (CN); Qingjie LIN, Shenzhen (CN); Yu WU, Shenzhen (CN); Taotao XIAO, Shenzhen (CN)

(21) Appl. No.: 16/996,762

(22) Filed: Aug. 18, 2020

Related U.S. Application Data
(63) Continuation of application No. PCT/CN2019/089555, filed on May 31, 2019.

(30) Foreign Application Priority Data
Jul. 5, 2018 (CN) 201810731500.0

(51) Int. Cl. G06F 9/445; G06F 9/451

(52) U.S. Cl. CPC G06F 9/44505; G06F 9/451

(57) ABSTRACT

This application provides a program operating method and a related apparatus. The method includes obtaining first operating data of the program from a server, the first operating data comprising at least an instruction for starting the program; executing the first operating data, and displaying a first page of the program according to the first operating data; determining, in response to a second triggering instruction of a control in the first page, a second page identifier corresponding to the control; obtaining second operating data from the server according to the second page identifier if operating data corresponding to the second page identifier is not in the first operating data, the second operating data comprising the operating data corresponding to the second page identifier; and executing the second operating data, and displaying a second page according to the second operating data, the second operating data comprising portions of the program.

### RELATED APPLICATIONS

This application claims priority to PCT Application No. PCT/CN2019/089555, filed on May 31, 2019, which claims priority to Chinese Patent Application No. 201810731500.0, entitled “PROGRAM OPERATING METHOD AND APPARATUS, COMPUTING DEVICE, AND STORAGE MEDIUM” filed with the China National Intellectual Property Administration on Jul. 5, 2018. The two applications are both incorporated herein by reference in their entirety.

### FIELD OF THE TECHNOLOGY

This application relates to the field of information technologies, and in particular, to a program operating method and apparatus, a computing device, and a storage medium.

### BACKGROUND OF THE DISCLOSURE

With the development of information technologies, online activities can meet an increasing number of needs of users, such as shopping, movie watching, financial management, and the like. A user can carry out online activities by installing various application programs on a terminal device.

### SUMMARY

This application provides the following technical solutions, which can speed up the starting time and operating time of a program.

Embodiments of this application provide a program operating method, performed by a computing device. The method includes obtaining, in response to a first triggering instruction of a program, first operating data of the program from a server, the first operating data comprising at least an instruction for starting the program; executing the first operating data, and displaying a first page of the program according to the first operating data; determining, in response to a second triggering instruction of a control in the first page, a second page identifier corresponding to the control; obtaining second operating data from the server according to the second page identifier if operating data corresponding to the second page identifier is not in the first operating data, the second operating data comprising the operating data corresponding to the second page identifier; and executing the second operating data, and displaying a second page according to the second operating data, the second operating data comprising portions of the program.

Embodiments of this application further provide a program operating method, performed by a computing device. The method includes receiving combination information related to a portion of a program; combining the portion of the program according to the combination information to generate a plurality of pieces of operating data; transmitting, if first obtaining request of the operating data is received, first operating data indicating that the program is started to a terminal device in response to the first obtaining request; and obtaining, if a second obtaining request, which carries a jump path, of the operating data is received, second operating data corresponding to the jump path, and transmitting the second operating data to the terminal device in response to the second obtaining request.

Embodiments of this application further provide a non-transitory storage medium storing one or more programs, the one or more programs comprising instructions, and the instructions, when executed by a computing device, causing the computing device to perform: receiving combination information related to a portion of a program; combining the portion of the program according to the combination information to generate a plurality of pieces of operating data; transmitting, if first obtaining request of the operating data is received, first operating data indicating that the program is started to a terminal device in response to the first obtaining request; and obtaining, if a second obtaining request, which carries a jump path, of the operating data is received, second operating data corresponding to the jump path, and transmitting the second operating data to the terminal device in response to the second obtaining request.

Embodiments of this application further provide a program operating apparatus. The apparatus includes a memory and a processor. The processor is configured to perform, obtaining, in response to a first triggering instruction of a program, first operating data of the program from a server, the first operating data comprising an instruction for starting the program; executing the first operating data, and displaying a first page of the program according to the first operating data; determining, in response to a second triggering instruction of a control in the first page, a second page identifier corresponding to the control; obtaining second operating data from the server according to the second page identifier if operating data corresponding to the second page identifier is not in the first operating data, the second operating data comprising the operating data corresponding to the second page identifier; and executing the second operating data, and displaying a second page according to the second operating data, the second operating data comprising a plurality portions of the program.

### BRIEF DESCRIPTION OF THE DRAWINGS

To describe the technical solutions in the embodiments of this application more clearly, the following briefly describes the accompanying drawings required for describing the embodiments. Apparently, the accompanying drawings in the following description show merely some embodiments of this application, and a person of ordinary skill in the art may still derive other drawings from the accompanying drawings without creative efforts.

FIG. 1 is a schematic structural diagram of a system to which a program operating method is applicable according to an embodiment of this application.

FIG. 2A is a flowchart of a program operating method according to an embodiment of this application.

FIG. 2B is a flowchart of a program operating method according to an embodiment of this application.

FIG. 2C is a flowchart of a program operating method according to an embodiment of this application.

FIG. 3 is an embodiment of displaying a page when a subpackage is run according to an embodiment of this application.

FIG. 4 is a flowchart of a program operating method according to an embodiment of this application.

FIG. 5A is a schematic structural diagram of a program operating apparatus according to an embodiment of this application.

FIG. 5B is a schematic structural diagram of a program operating apparatus according to an embodiment of this application.

FIG. 5C is a schematic structural diagram of a program operating apparatus according to an embodiment of this application.

FIG. 6 is a schematic structural diagram of a program operating apparatus according to an embodiment of this application.

FIG. 7 is a schematic structural diagram of hardware of a computing device according to an embodiment of this application.

### DESCRIPTION OF EMBODIMENTS

The following clearly and completely describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

To provide brief and intuitive descriptions, the following describes the solutions of this application by describing several embodiments. Details in the embodiments are only used to help understand the solutions of this application. Implementation of the technical solutions of this application is not limited to the details. To avoid making the solutions of this application obscure, some implementations are not described in detail, but only a framework is provided. In the following description, “including” means “including but not limited to”, and “according to . . . ” means “according to at least . . . , but not limited to according only to . . . ”. A number of elements is not particularly specified in the following descriptions, it means that there may be one or more elements, or it may be understood that there is at least one element.

When a user obtains an application program to be installed on a terminal device, a time delay problem may occur when the application program is downloaded and run due to an excessive size of the application program, and therefore, reducing such time delay is the key to resolving the foregoing problem.

In view of this, the embodiments of this application provide a program operating method and apparatus, a computing device, and a storage medium. For applying the technical solutions of this application, a starting resource of a program, that is, first operating data, may be pulled first, to reduce the time consumption due to download of excessive amount of data, and starting time can be accelerated when the program is started, to bring a user good use experience. When the user performs a program operation, a page identifier to be displayed, that is, a second page identifier, is determined according to an instruction of the user. When the second page identifier is not in the starting resource, other operating resources of the program, such as second operating data, are pulled according to the second page identifier, where the second operating data includes operating data corresponding to the second page identifier, thereby greatly optimizing the operating speed of the program.

The technical solutions are implemented based on a parent application system and a child application system. Specifically, the child application is an application program that runs with dependence on the parent application, and the child application may be downloaded, started, run, and closed by using the parent application. The parent application may be a social networking application, a specific application dedicated to supporting the child application, a file management application, a mail application, a game application, or the like. The social networking application includes an instant messaging application (for example, WeChat), a social networking network service (SNS) application, a live broadcast application, or the like. The child application is an application that can be implemented in an environment provided by the parent application, and the child application may be specifically a social networking application, a file management application, a mail application, a game application, or the like.

Description is made by using an example in which the parent application is WeChat and the child application is a WeChat applet. The WeChat applet is a new open function, and a developer can quickly develop an applet. The applet may be easily acquired and propagated in WeChat, while having excellent use experience. The applet builds a system for operating third-party programs in the WeChat application. By using a method, such as scanning a QR code through WeChat, searching for the name of the applet, clicking on a shared message or the like, the WeChat applet (that is, a third-party program) is downloaded and run to provide a service to the user. Each WeChat applet has a corresponding code package, and the code package needs to be first downloaded locally before the applet is run. Therefore, there is certainly a download process for the first time of starting the applet on the user side. It is time-consuming to download a large code package, and the time consumption of the download affects the starting time consumption. The larger the code package is, the greater the impact on the starting time consumption is.

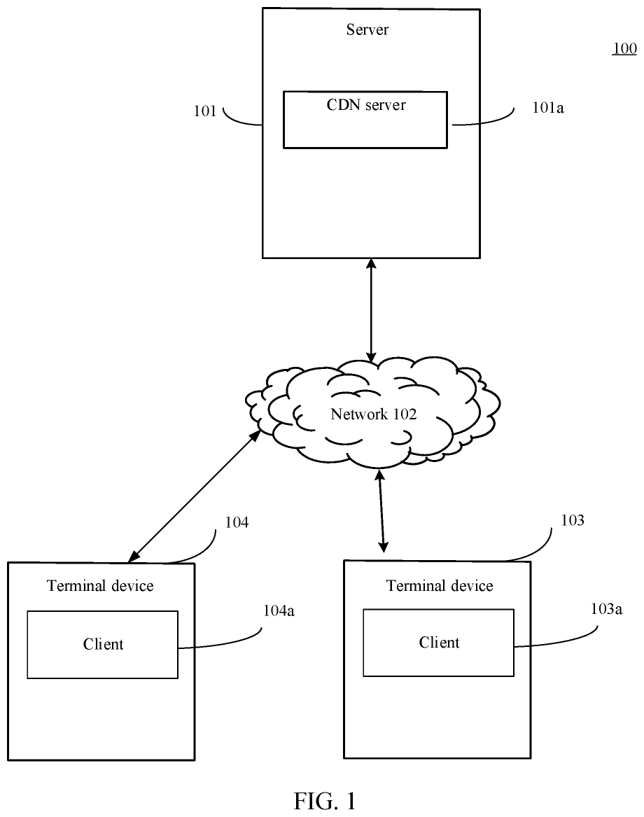

FIG. 1 is a schematic structural diagram of a system 100 to which a program operating method is applicable according to an embodiment of this application. The system 100 includes a server 101, a network 102, and a plurality of terminal devices, such as a terminal device 103 and a terminal device 104.

Application server software for splitting a program is installed in the server 101, and the program is split into a plurality of subpackages and a starting package. The server 101 may further include a plurality of content delivery network (CDN) servers 101a to which the subpackages and the starting package are transmitted. When any CDN server receives an obtaining request transmitted by a client, a corresponding starting package or subpackage is transmitted to the client.

The terminal device 103 or 104 refers to a device having a data computing processing function and includes, but is not limited to, a smartphone (in which a communications module is installed), a palmtop computer, a tablet computer, or the like. Operating systems are installed on the terminal devices, including but not limited to the Android operating system, the Symbian operating system, the Windows mobile operating system, the Apple iPhone OS operating system, or the like.

A client 103a or 104a (for example, a social APP) is installed in the terminal device 103 or 104. The client performs information exchange with the server 101 through the network 102. The client may transmit an obtaining request to the server 101 to obtain a subpackage or starting package.

The network 102 may be a wired network, or a wireless network.

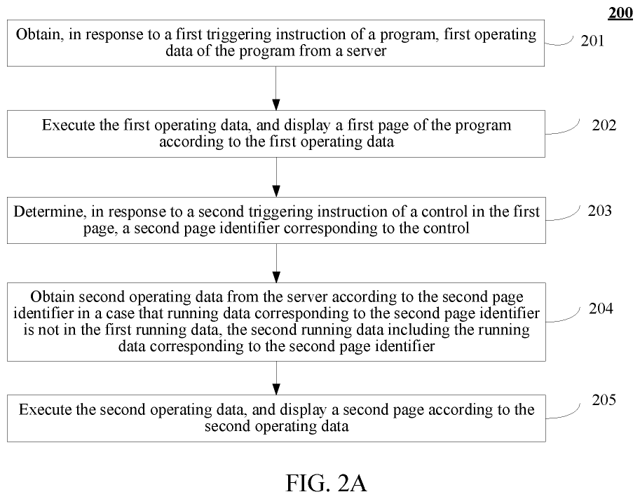

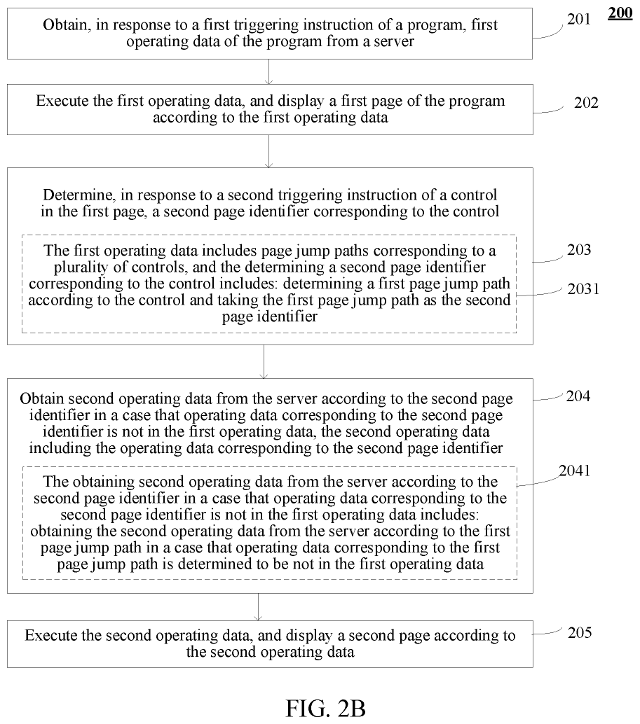

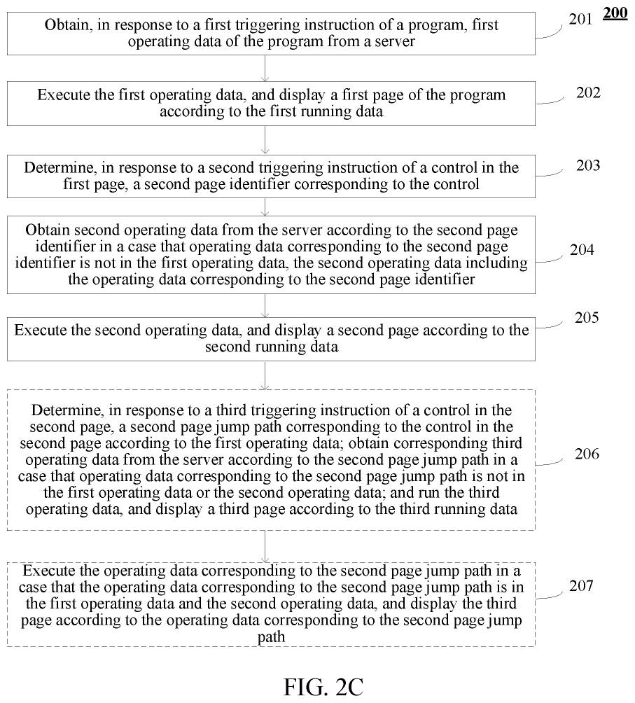

Base on the system 100, according to this embodiment of this application, a program operating method is provided, and is applied to a client of the terminal device 103 or 104. As shown in FIG. 2, the method 200 includes the following steps:

Step 201: Obtain, in response to a first triggering instruction of a program, first operating data of the program from a server.

The first triggering instruction may be a program starting instruction.

The first operating data includes at least code used for starting the program, and the code may be a program starting package, the program starting package including program starting code used for starting the program. The starting package may run the code only on a program homepage, or may have other functions to run the code.

The obtaining the first operating data of the program from the server includes: transmitting the obtaining request to the server, the obtaining request carrying an identifier of the program; and receiving the first operating data transmitted by the server in response to the obtaining request.

For example, according to the foregoing description, the user may search for the applet named “XX video” through the WeChat APP. After the applet is found, the user gives an instruction to start the applet, that is, click the found applet. In response to the triggering instruction, the WeChat APP transmits an applet obtaining request to the server, and the obtaining request may carry an identifier of the applet. After receiving the obtaining request, the server transmits the starting package of the applet to the WeChat APP in response to the obtaining request.

Step 202: Execute the first operating data, and display a first page of the program according to the first operating data.

The first page may be a starting page or a homepage of the program.

In some embodiments, the executing the first operating data includes: executing the first operating data by using an operating container. After the first operating data is run, the starting page of the applet may be displayed.

Step 203: Determine, in response to a second triggering instruction of a control in the first page, a second page identifier corresponding to the control.

The second triggering instruction may include, but not limited to a page jump instruction, such as a video watching instruction, a music listening instruction, a game loading instruction, or the like.

The second page may be a jump page other than the starting page, such as a video watching page, a music listening page, or the like.

The control may be, but not limited to an icon, a button, or the like.

In some embodiments, as shown in FIG. 2B, the first operating data includes page jump paths corresponding to a plurality of controls. Step 2031: The determining a second page identifier corresponding to the control includes: determining a first page jump path according to the control and taking the first page jump path as the second page identifier.

The plurality of controls may include a plurality of controls included in the first operating data, and may further include controls included in other operating data, such as controls in second operating data.

For example, according to the foregoing description, when the user clicks a video introduction icon in a starting page of a video applet, that is, the user gives a second triggering instruction to watch the video, the WeChat APP determines a page jump path in response to the second triggering instruction.

Step 204: Obtain second operating data from the server according to the second page identifier in a case that operating data corresponding to the second page identifier is not in the first operating data, the second operating data including the operating data corresponding to the second page identifier.

The second operating data includes portions the program, the portions of the program may include a program subpackage, and the subpackage includes program function code used for supporting function operating of the program. The function code in the subpackage may be a type of function code, such as movie-related function code, music-related function code, or news-related function code.

Code of the applet may be divided according to functions. Views and the logic of pages under the same function are placed under the same directory, and some cross-functional common logic is placed under the starting package.

In some embodiments, as shown in FIG. 2B, Step 2041: The obtaining second operating data from the server according to the second page identifier in a case that operating data corresponding to the second page identifier is not in the first operating data includes: obtaining the second operating data from the server according to the first page jump path in a case that operating data corresponding to the first page jump path is determined to be not in the first operating data.

Step 205: Execute the second operating data, and display a second page according to the second operating data.

In some embodiments, the executing the second operating data includes: executing the second operating data by using the operating container, and displaying a second page of the applet after the second operating data is run.

In the technical solution provided in this embodiment of this application, loading may be performed according to requirements of a user by dividing the applet code package into a starting package and a plurality of subpackages, so that starting experience of the user is not affected in a case that a larger applet code package size can be supported.

In some embodiments, the obtaining the first operating data of the program from the server includes: transmitting the obtaining request to the server, the obtaining request carrying an identifier of the program; and receiving the first operating data transmitted by the server in response to the obtaining request.

For example, according to the foregoing description, the user may search for the applet named “XX video” through the WeChat APP. After the applet is found, the user gives an instruction to start the applet, that is, click the found applet. In response to the triggering instruction, the WeChat APP transmits an applet obtaining request to the server, and the obtaining request may carry an identifier of the applet. After receiving the obtaining request, the server transmits the starting package code of the applet to the WeChat APP in response to the obtaining request. The starting package may only include the operating code of the starting page of the video applet, such as, initial page view layer code and initial page logical code.

In some embodiments, the executing the first operating data includes: executing the first operating data by using an operating container. The method 200 further includes: storing the obtained first operating data in a local storage area; obtaining the first operating data in the local storage area, and transmitting the first operating data to the operating container; and performing the step of executing the first operating data by using the operating container after the first operating data is transmitted to the operating container.

The first operating data includes first logical operating data and first view operating data corresponding to the first page.

The obtaining the first operating data in the local storage area, and transmitting the first operating data to the operating container includes: obtaining the first logical operating data in the local storage area, and transmitting the first logical operating data to the operating container; and obtaining the first view operating data in the local storage area, and transmitting the first view operating data to the operating container after the operating container runs the first logical operating data, and then displaying the first page of the program.

The operating container may be a JavaScriptCore operating container.

The first logical operating data corresponding to the first page is first logical code, that is, logical code of the starting page of the applet.

The first view operating data corresponding to the first page is first view layer code, that is, view layer code of the starting page of the applet.

For example, according to the foregoing description, after the WeChat APP receives the first operating data transmitted by the server, the first operating data may be stored in the local storage area of the terminal device. The WeChat APP obtains the first operating data from the local storage area, injects the first logical code into the JavaScriptCore operating container, and injects the first view layer code after the JavaScriptCore operating container runs the first logical code, to display an initial page of the video applet to the user.

The JavaScriptCore operating container may be provided with a logical layer unit and a view layer unit. The logical layer unit may be used for executing page logical code, and the view layer unit may be used for executing page style code, that is, page view layer code. The logical layer unit runs the page logical code to obtain page data, and transmits the page data to a corresponding view layer unit. The view layer unit renders the page according to the page data. After the rendering is completed, the corresponding view layer unit transmits a notification of rendering completion to the logical layer unit. After the rendering is completed, the operating system of the terminal device displays the rendered page in an application program window.

In some embodiments, the method 200 further includes: executing the second operating data in a case that the operating data corresponding to the second page identifier is not in the first operating data, and displaying the second page according to the second operating data.

The first operating data includes page jump paths corresponding to a plurality of controls. The determining a second page identifier corresponding to the control includes: determining a first page jump path according to the control and taking the first page jump path as the second page identifier; and the obtaining second operating data from the server in a case that operating data corresponding to the second page identifier is not in the first operating data including: obtaining the second operating data from the server according to the first page jump path in a case that operating data corresponding to the first page jump path is determined to be not in the first operating data.

The second operating data includes second logical operating data and second view operating data corresponding to a plurality of page jump paths. The method 200 further includes: storing the obtained second operating data in a local storage area.

In an embodiment of this application, the second logical operating data is second logical code, and the second view operating data is second view layer code.

The executing the second operating data includes: executing the second operating data by using the operating container.

The executing the second operating data, and displaying the second page according to the second operating data includes: obtaining the second logical operating data that corresponds to a first page jump path and that is in the local storage area, and transmitting the second logical operating data to an operating container; and obtaining the second view operating data that corresponds to the first page jump path and that is in the local storage area, and transmitting the second view operating data to the operating container after the operating container runs the second logical operating data corresponding to the first page jump path, and then displaying the second page.

For example, according to the foregoing description, when the user clicks a “bb” movie video introduction icon in the starting page of the video applet, that is, the user gives a second triggering instruction to watch the “bb” movie video, the WeChat APP, in response to the second triggering instruction of the control, determines a page jump path such as “aaa” according to the correspondence between the control stored in the first operating data and the page jump path, and uses the page jump path as a page identifier of playing the “bb” movie video. The WeChat APP first determines whether there is operating data corresponding to “aaa” through search in the first operating data, and then transmits an obtaining request to the server when there is no operating data, the obtaining request carrying the page jump path “aaa”. The server searches for subpackage code corresponding to the page jump path “aaa” according to the page jump path “aaa”, that is, the second operating data. The subpackage code includes the operating data corresponding to the page jump path “aaa”. The server transmits the second operating data to the WeChat APP. The second operating data may be stored in the local storage area of the terminal device. The WeChat APP obtains the second operating data from the local storage area, and injects the second logical code corresponding to the page jump path “aaa” into the JavaScriptCore operating container, and injects the second view layer code corresponding to the page jump path “aaa” after the JavaScriptCore operating container runs the second logical code, to display a second page of the video applet, that is, a page that plays the “bb” movie video to the user.

The starting package can store the page jump paths corresponding to all controls of the applet. The starting package can further only store page jump paths corresponding to controls in the starting package. The subpackage stores page jump paths corresponding to controls in the subpackage. When the subpackage stores the page jump paths corresponding to the controls in the subpackage, the page jump paths may be determined through the subpackage, and whether there is operating data corresponding to the page jump paths may be determined through search in a currently obtained code package.

In some embodiments, the method 200 further includes: operating the operating data corresponding to the second page identifier in a case that the operating data corresponding to the second page identifier is in the first operating data, and displaying the second page according to the operating data corresponding to the second page identifier.

In some embodiments, the first operating data further includes second logical operating data and second view operating data corresponding to a plurality of page jump paths. The method 200 further includes: obtaining the second logical operating data that corresponds to the first page jump path and that is in the local storage area, and transmitting the second logical operating data to the operating container in a case that the operating data corresponding to the first page jump path is determined to be in the first operating data; and obtaining the second view operating data that corresponds to the first page jump path and that is in the local storage area, and transmitting the second view operating data to the operating container after the operating container runs the second logical operating data corresponding to the first page jump path, and then displaying the second page of the program.

For example, according to the foregoing description, when the operating data is in the first operating data, logical code and view layer code that are in the local storage area and that correspond to the page jump path “aaa” are obtained. The logical code corresponding to the page jump path “aaa” is injected into the JavaScriptCore operating container. The view layer code corresponding to the page jump path “aaa” is injected into the JavaScriptCore operating container after the JavaScriptCore operating container runs the logical code, to display the second page of the video applet, that is, the page that plays the “bb” movie video to the user.

When the operating data is in the first operating data, because only starting logical code and starting view layer code may be run when the applet is initialized, that is, started, other logical code and corresponding view layer code in the first operating data need to be injected into the operating container when the other logical code and the corresponding view layer code are selected.

In some embodiments, as shown in FIG. 2C, the method 200 further includes the following step: Step 206: Determine, in response to a third triggering instruction of a control in the second page, a second page jump path corresponding to the control in the second page according to the first operating data; obtain corresponding third operating data from the server according to the second page jump path in a case that operating data corresponding to the second page jump path is not in the first operating data or the second operating data; and run the third operating data, and display a third page according to the third operating data, the third operating data including the operating data corresponding to the second page jump path.

In an embodiment of this application, the third operating data includes third logical operating data and third view operating data corresponding to the second page jump path. In an embodiment of this application, the third logical operating data is third logical code, and the third view operating data is third view layer code.

For example, according to the foregoing description, when a user clicks a “cc” news video introduction icon in the page that plays the “bb” movie video, that is, the user gives a third triggering instruction to watch the “cc” news video, the WeChat APP, in response to the third triggering instruction of the control, determines a page jump path such as “ddd” according to the correspondence between the control stored in the first operating data and the page jump path, and uses the page jump path as a page identifier of playing the “cc” news video. The WeChat APP first determines whether there is operating data corresponding to “ddd” through search in the first operating data and the second operating data, and then transmits an obtaining request to the server when the operating data is in neither the first operating data nor the second operating data, the obtaining request carrying the page jump path “ddd”. The server searches for subpackage code corresponding to the page jump path “ddd” according to the page jump path “ddd”, that is, the third operating data. The subpackage code includes the operating data corresponding to the page jump path “ddd”. The server transmits the third operating data to the WeChat APP. The third operating data may be stored in the local storage area of the terminal device. The WeChat APP obtains the third operating data from the local storage area, and injects the third logical code corresponding to the page jump path “ddd” into the JavaScriptCore operating container, and injects the third view layer code corresponding to the page jump path “ddd” after the JavaScriptCore operating container runs the third logical code, to display a third page of the video applet, that is, a page that plays the “cc” news video to the user.

In addition, the second page jump path that corresponds to the control in the second page may also be determined according to the second operating data.

In some embodiments, as shown in FIG. 2C, the method 200 further includes the following step: Step 207: Run the operating data corresponding to the second page jump path in a case that the operating data corresponding to the second page jump path is in the first operating data and the second operating data, and display the third page according to the operating data corresponding to the second page jump path.

For example, according to the foregoing description, when the operating data is in the first operating data or the second operating data, the logical code corresponding to the page jump path “ddd” is injected into the JavaScriptCore operating container. The view layer code corresponding to the page jump path “ddd” is injected into the JavaScriptCore operating container after the JavaScriptCore operating container runs the logical code, to display the third page of the video applet, that is, the page that plays the “cc” news video to the user.

When the operating data is in the first operating data, because only starting logical code and starting view layer code may be run when the applet is initialized, that is, started, other logical code and corresponding view layer code in the first operating data need to be injected into the operating container when the other logical code and the corresponding view layer code are selected. The operating status of the second operating data is the same as the operating status of the first operating data, and details are not described herein again.

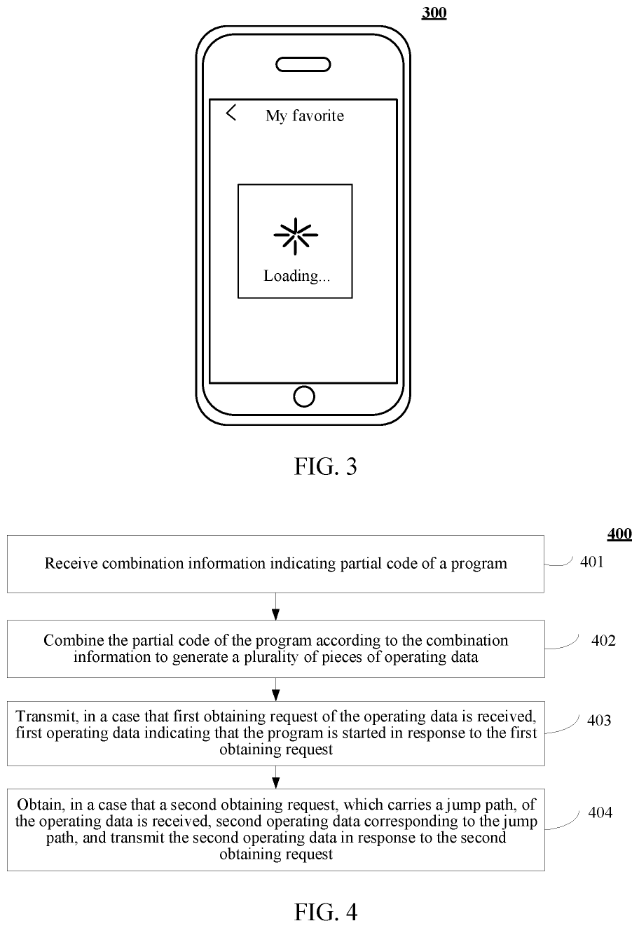

In a process in which the user uses the applet, when a page is opened after the WeChat APP runs subpackage code, loading the page appears briefly, generally within 1 second. FIG. 3 shows an example 300 of the loading the page, and then the page under the subpackage is displayed in front of the user.

The upper limit of the total size of the starting package and a plurality of subpackages of the applet is increased from 2 MB to 4 MB. The service side can add more applet functions, and the user can obtain a richer experience on the applet. The starting package may be controlled to a smaller size by properly splitting the starting package to optimize the starting speed of the applet.

Base on the foregoing embodiment, according to an embodiment of this application, a program operating method is provided, and is applied to a server 101. As shown in FIG. 4, the method 400 includes the following steps:

Step 401: Receive combination information indicating portions of a program.

In an embodiment of this application, a developer splits the code of the applet according to functions, into a plurality of code files, that is, portions of code/program, which are stored in the server, respectively. The developer can complete the development of the subpackage by configuring a subpackage combination path, that is, the combination information under app.j son (an applet configuration file), which may be released with one click by using a WeChat developer tool without considering any issue at the serving end. The server receives the configuration information file transmitted by the WeChat developer tool, that is, obtains the combination information.

The following description is a code example in the configuration file:

{

“pages”:[

“pages/index”,

“pages/logs”
],
“subpackages”:[

{

“root”:“packageA”

“pages”:[

“pages/cat”,
“pages/dog”

]

},{
“root”:“packageB”,
“pages”:[

“pages/apple”,
“pages/banana”,

]

}

]

}

Step 402: Combine the portions of the program according to the combination information to generate a plurality of pieces of operating data.

In an embodiment of this application, according to the foregoing description, the server combines a plurality of code files according to the split information of the starting package and the subpackages in the configuration file to generate the starting package and a plurality of subpackages of the applet, which may be stored in different CDN servers 101a. The storage addresses thereof may be, for example: https://servicewhat.xx.com/wxidxxx/main.wxapkg, https://servicewhat.xx.com/wxidxxx/subpackage1.wxapkg, and https://servicewhat.xx.com/wxidxxx/subpackage2.wxapkg.

Step 403: Transmit, in a case that first obtaining request of the operating data is received, first operating data indicating that the program is started in response to the first obtaining request.

In an embodiment of this application, according to the foregoing description, when the server receives an obtaining request that is transmitted by the WeChat APP run on the terminal device, where the obtaining request may carry an identifier of the applet, the server transmits the starting package of the applet to the WeChat APP in response to the obtaining request.

Step 404: Obtain, in a case that a second obtaining request, which carries a jump path, of the operating data is received, second operating data corresponding to the jump path, and transmit the second operating data in response to the obtaining request.

In an embodiment of this application, according to the foregoing description, the WeChat APP transmits a code obtaining request to the server. The code obtaining request carries the page jump path “aaa”. The server searches for subpackage code corresponding to the page jump path “aaa” according to the page jump path “aaa”, that is, the second operating data. The subpackage code includes the operating data corresponding to the page jump path “aaa”. The server transmits the second operating data to the WeChat APP.

The technical solution provided by this embodiment of this application has low development costs. A developer can combine and pack split code without performing a plurality of configurations, and store the split code in the server without considering browser caching.

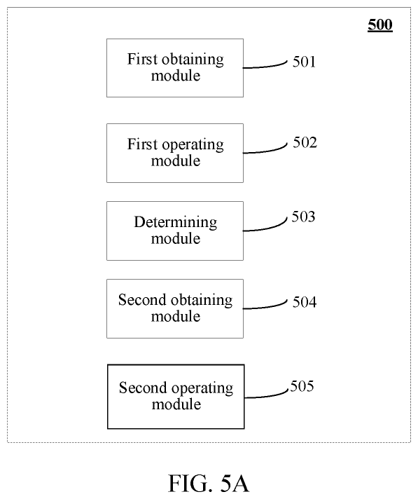

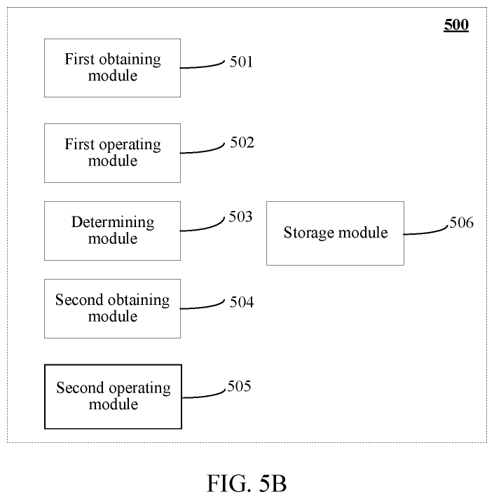

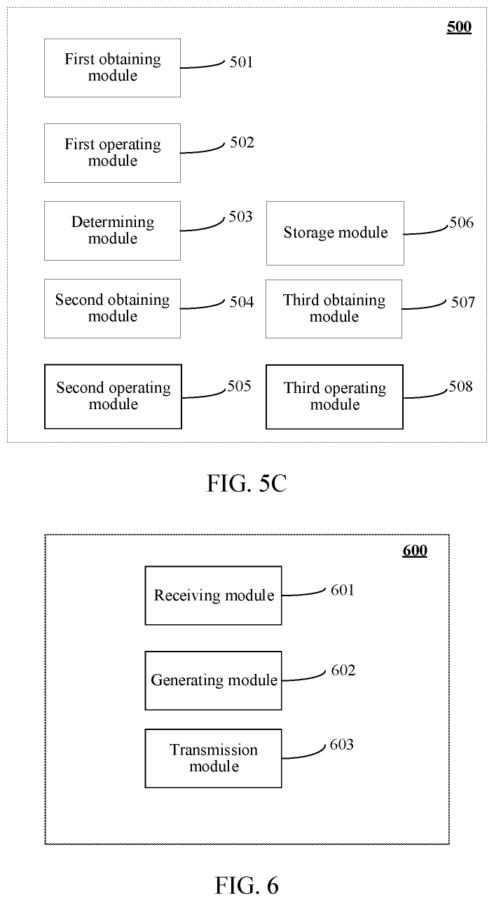

Base on the foregoing embodiment, according to an embodiment of this application, a program operating apparatus is further provided, and is applied to a client run on a computing device, such as a social APP. As shown in FIG. 5A, the apparatus 500 includes: a first obtaining module 501, a first operating module 502, a determining module 503, a second obtaining module 504 and a second operating module 505. Functions of the modules are specifically as follows:

The first obtaining module 501 obtains, in response to a first triggering instruction of a program, first operating data of the program from a server, the first operating data including at least code used for starting the program.

The first operating module 502 runs the first operating data, and displays a first page of the program according to the first operating data.

The determining module 503 determines, in response to a second triggering instruction of a control in the first page, a second page identifier corresponding to the control.

The second obtaining module 504 obtains second operating data from the server according to the second page identifier in a case that operating data corresponding to the second page identifier is not in the first operating data, the second operating data including the operating data corresponding to the second page identifier.

The second operating module 505 runs the second operating data, and displays a second page according to the second operating data, the second operating data including portions of the program.

In some embodiments, the second operating module 505 runs the operating data corresponding to the second page identifier in a case that the operating data corresponding to the second page identifier is in the first operating data, and displays the second page according to the operating data corresponding to the second page identifier.

In some embodiments, the first obtaining module 501 includes: a transmission unit, transmitting an obtaining request to the server, the obtaining request carrying an identifier of the program; and a receiving unit, receiving the first operating data transmitted by the server in response to the obtaining request.

In some embodiments, the first operating module 502 runs the first operating data by using an operating container; and the second operating module 505 runs the second operating data by using the operating container.

In some embodiments, as shown in FIG. 5B, the apparatus 500 further includes: a storage module 506, storing the obtained first operating data in a local storage area; the first obtaining module 501 obtains the first operating data in the local storage area, and transmits the first operating data to the operating container; and the first operating module 502 performs the step of executing the first operating data by using the operating container after the first operating data is transmitted to the operating container.

In some embodiments, the first operating data includes first logical operating data and first view operating data corresponding to the first page, and the first obtaining module 501 includes: a first obtaining unit, obtaining the first logical operating data in the local storage area, and transmitting the first logical operating data to the operating container; and a second obtaining unit, obtaining the first view operating data in the local storage area, and transmitting the first view operating data to the operating container after the operating container runs the first logical operating data, and then displaying the first page of the program.

In some embodiments, the first operating data includes page jump paths corresponding to a plurality of controls, the determining module 503 determines a first page jump path according to the control and takes the first page jump path as the second page identifier; and the second obtaining module 504 obtains the second operating data from the server according to the first page jump path in a case that operating data corresponding to the first page jump path is determined to be not in the first operating data.

In some embodiments, the determining module 503 determines, in response to a third triggering instruction of a control in the second page, a second page jump path corresponding to the control in the second page according to the first operating data; as shown in FIG. 5C, the apparatus 500 further includes: a third obtaining module 507, obtaining corresponding third operating data from the server according to the second page jump path in a case that operating data corresponding to the second page jump path is not in the first operating data or the second operating data, the third operating data including the operating data corresponding to the second page jump path; and a third operating module 508, operating the third operating data, and displaying the third page according to the third operating data.

In some embodiments, the first operating module 502 runs the operating data corresponding to the second page jump path in a case that the operating data corresponding to the second page jump path is in the first operating data, and displays the third page according to the operating data corresponding to the second page jump path.

In some embodiments, the first operating data further includes second logical operating data and second view operating data corresponding to a plurality of page jump paths, and the first obtaining module 501 obtains the second logical operating data that corresponds to the first page jump path and that is in the local storage area, and transmits the second logical operating data to the operating container in a case that the operating data corresponding to the first page jump path is determined to be in the first operating data; and obtains the second view operating data that corresponds to the first page jump path and that is in the local storage area, and transmits the second view operating data to the operating container after the operating container runs the second logical operating data corresponding to the first page jump path, and then displays the second page of the program.

In some embodiments, the second operating data includes second logical operating data and second view operating data corresponding to a plurality of page jump paths, and the storage module 506 stores the obtained second operating data in a local storage area. The second operating module 505 includes: an obtaining unit, obtaining the second logical operating data that corresponds to a first page jump path and that is in the local storage area, and transmitting the second logical operating data to an operating container; and obtaining the second view operating data that corresponds to the first page jump path and that is in the local storage area, and transmitting the second view operating data to the operating container after the operating container runs the second logical operating data corresponding to the first page jump path, and then displaying the second page.

Base on the foregoing embodiment, according to an embodiment of this application, a program operating apparatus is further provided, and is applied to a server 101. As shown in FIG. 6, the apparatus 600 includes: a receiving module 601, a generating module 602 and a transmission module 603. Functions of the modules are specifically as follows:

The receiving module 601 receives combination information indicating portions of a program.

The generating module 602 combines the portions the program according to the combination information to generate a plurality of pieces of operating data.

The transmission module 603 transmits, in a case that first obtaining request of the operating data is received, first operating data indicating that the program is started in response to the first obtaining request.

The transmission module 603 obtains, in a case that a second obtaining request, which carries a jump path, of the operating data is received, second operating data corresponding to the jump path, and transmits the second operating data in response to the second obtaining request.

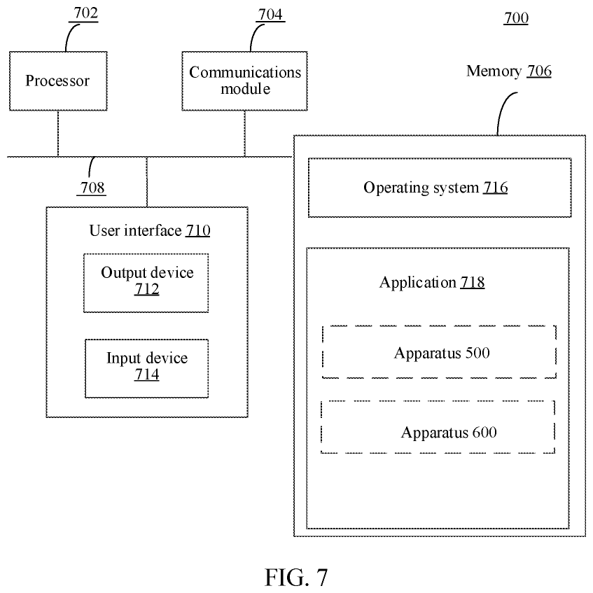

FIG. 7 is a structural composition diagram of a computing device 700 in which an operating apparatus 500 and/or an operating apparatus 600 is located. The computing device 700 may be a server or a terminal device. As shown in FIG. 7, the computing device includes one or more processors (CPU) 702, a communications module 704, a memory 706, a user interface 710, and a communications bus 708 for interconnecting the components.

The processor 702 may receive and transmit data by using the communications module 704 to implement network communication and/or local communication.

The user interface 710 includes one or more output devices 712, including one or more speakers and/or one or more visual displays. The user interface 710 may further include one or more input devices 714, including, such as, a keyboard, a mouse, a voice command input unit or a speaker, a touchscreen display, a touch-sensitive panel, a gesture capture camera, another input button, a control, or the like.

The memory 706 may be a high-speed random access memory such as a dynamic random access memory (DRAM), a static random-access memory (SRAM), a double data rate random-access memory (DDR RAM), or another random access solid-state storage device; or a non-volatile memory such as one or more magnetic storage devices, an optical disc storage device, a flash memory, or another non-volatile solid-state storage device.

The memory 706 stores an instruction set that can be performed by the memory 702, and includes:

an operating system 716, including a program configured to process various basic system services and execute a hardware-related task; and

an application 718, including various application programs, such an application program being capable of implementing the processing processes in the foregoing embodiments, and including, for example, some of the modules or all the modules in the operating apparatus 500 as shown in FIG. 5A to FIG. 5C, at least one of the modules 501 to 508 storing a machine executable instruction, and the processor 702, by executing a machine executable instruction in at least one of the modules 501 to 508 in the memory 706, implementing a function of the at least one of the modules 501 to 508.

Such an application program can include, for example, some of the modules or all the modules in the operating apparatus 600 as shown in FIG. 6. At least one of the modules 601 to 603 can store a machine executable instruction. The processor 702, by executing a machine executable instruction in at least one of the modules 601 to 603 in the memory 706, implementing a function of the at least one of the modules 601 to 603.

Not all of the steps and modules in the foregoing processes and structural diagrams are necessary, and certain steps or modules can be neglected according to actual requirements. An execution sequence of the steps is not fixed and may be adjusted according to requirements. Division of the modules is merely functional division for ease of description. During actual implementation, one module may be implemented separately by a plurality of modules, and functions of the plurality of modules may alternatively be implemented by the same module. The modules may be located in the same device, or may be located in different devices.

A hardware module in each embodiment may be implemented in a hardware manner or in a hardware platform combining with software manner. The software includes a machine-readable instruction, stored in a non-volatile storage medium. Therefore, the embodiments may alternatively be implemented in a form of a software product.

In each embodiment, hardware may be implemented by hardware of dedicated hardware or hardware executing the machine-readable instruction. For example, the hardware may be a specifically designed permanent circuit or logical device (for example, a dedicated processor, such as an FPGA or an ASIC) for completing a specific operation. The hardware may alternatively include a programmable logical device or circuit (for example, including a general processor or another programmable processor) configured temporarily by software and configured to perform a specific operation.

In addition, each example of this application may be implemented by a data processing program executed by a data processing device such as a computer. Apparently, data processing programs constitutes this application. In addition, generally, a data processing program stored in a storage medium is directly read from the storage medium for execution or the program is installed on or replicated to a storage device (for example, a hard disk or a memory) of a data processing device for execution. Therefore, such a storage medium constitutes this application. This application further provides a non-volatile the storage medium storing a data processing program. The data processing program may be configured to perform any instance in the foregoing method embodiments in this application.

The machine-readable instruction corresponding to a module in FIG. 5 and/or FIG. 6 may enable an operating system and the like operated on a computer to complete some or all operations described herein. The non-volatile computer-readable storage medium may be a memory inserted into an expansion board inserted in the computer or a memory written to an expansion unit connected to the computer. A central processing unit (CPU) or the like installed on the expansion board or the expansion unit may perform some and all actual operations according to an instruction.

In addition, modules in the embodiments of this application may be integrated into one processing unit, or each of the modules may exist alone physically, or two or more apparatus or modules may be integrated into one unit. The integrated unit may be implemented in the form of hardware, or may be implemented in the form of a software function unit.

The above descriptions are merely preferred embodiments of this application, but are not intended to limit this application. Any modification, equivalent replacement, or improvement made within the spirit and principle of this application shall all fall within the protection scope of this application.

What is claimed is:

1. A program operating method, performed by a computing device, the method comprising:
obtaining, in response to a first triggering instruction of a program, first operating data of the program from a server, the first operating data comprising at least an instruction for starting the program;
executing the first operating data, and displaying a first page of the program according to the first operating data;
determining, in response to a second triggering instruction of a control in the first page, a second page identifier corresponding to the control;
obtaining second operating data from the server according to the second page identifier if operating data corresponding to the second page identifier is not in the first operating data, the second operating data comprising the operating data corresponding to the second page identifier; and
executing the second operating data, and displaying a second page according to the second operating data, the second operating data comprising portions of the program.

2. The method according to claim 1, further comprising:
executing the operating data corresponding to the second page identifier if the operating data corresponding to the second page identifier is in the first operating data, and displaying the second page according to the operating data corresponding to the second page identifier.

3. The method according to claim 1, wherein the obtaining first operating data of the program from a server comprises:
transmitting an obtaining request to the server, the obtaining request carrying an identifier of the program; and
receiving the first operating data transmitted by the server in response to the obtaining request.

4. The method according to claim 1, the executing the first operating data comprising: executing the first operating data by using an operating container; and
the executing the second operating data comprising: executing the second operating data by using the operating container.

5. The method according to claim 4, further comprising:
storing the obtained first operating data in a local storage area;
obtaining the first operating data in the local storage area, and transmitting the first operating data to the operating container; and
executing the first operating data by using the operating container after the first operating data is transmitted to the operating container.

6. The method according to claim 5, the first operating data comprising first logical operating data and first view operating data corresponding to the first page; and
the obtaining the first operating data in the local storage area, and transmitting the first operating data to the operating container comprising:
obtaining the first logical operating data in the local storage area, and transmitting the first logical operating data to the operating container; and
obtaining the first view operating data in the local storage area, and transmitting the first view operating data to the operating container after the operating container runs the first logical operating data, and then displaying the first page of the program.

7. The method according to claim 1, the first operating data comprising page jump paths corresponding to a plurality of controls;
the determining a second page identifier corresponding to the control comprising:
determining a first page jump path according to the control and taking the first page jump path as the second page identifier; and
the obtaining second operating data from the server according to the second page identifier if operating data corresponding to the second page identifier is not in the first operating data comprising:
obtaining the second operating data from the server according to the first page jump path if operating data corresponding to the first page jump path is determined to be not in the first operating data.

8. The method according to claim 7, further comprising:
determining, in response to a third triggering instruction of a control in the second page, a second page jump path corresponding to the control in the second page according to the first operating data;
obtaining corresponding third operating data from the server according to the second page jump path if operating data corresponding to the second page jump path is not in the first operating data or the second operating data, the third operating data comprising the operating data corresponding to the second page jump path; and
operating the third operating data, and displaying a third page of the program according to the third operating data.

9. The method according to claim 8, further comprising:
executing the operating data corresponding to the second page jump path if the operating data corresponding to the second page jump path is in the first operating data, and displaying the third page according to the operating data corresponding to the second page jump path.

10. The method according to claim 7, the first operating data further comprising second logical operating data and second view operating data corresponding to a plurality of page jump paths; and
the method further comprising:
obtaining the second logical operating data that corresponds to the first page jump path and that is in the local storage area, and transmitting the second logical operating data to the operating container if the operating data corresponding to the first page jump path is determined to be in the first operating data; and
obtaining the second view operating data that corresponds to the first page jump path and that is in the local storage area, and transmitting the second view operating data to the operating container after the operating container runs the second logical operating data corresponding to the first page jump path, and then displaying the second page of the program.

11. The method according to claim 1, the second operating data comprising second logical operating data and second view operating data corresponding to a plurality of page jump paths, the method further comprising:
storing the obtained second operating data in a local storage area; and
the executing the second operating data, and displaying a second page according to the second operating data comprising:
obtaining the second logical operating data that corresponds to a first page jump path and that is in the local storage area, and transmitting the second logical operating data to an operating container; and
obtaining the second view operating data that corresponds to the first page jump path and that is in the local storage area, and transmitting the second view operating data to the operating container after the operating container runs the second logical operating data corresponding to the first page jump path, and then displaying the second page.

12. A non-transitory storage medium storing one or more programs, the one or more programs comprising instructions, and the instructions, when executed by a computing device, causing the computing device to perform:
receiving combination information related to a portion of a program;
combining the portion of the program according to the combination information to generate a plurality of pieces of operating data;
transmitting, if first obtaining request of the operating data is received, first operating data indicating that the program is started to a terminal device in response to the first obtaining request; and
obtaining, if a second obtaining request, which carries a jump path, of the operating data is received, second operating data corresponding to the jump path, and transmitting the second operating data to the terminal device in response to the second obtaining request.

13. A program operating apparatus, comprising: a memory and a processor, the processor being configured to perform:
obtaining, in response to a first triggering instruction of a program, first operating data of the program from a server, the first operating data comprising an instruction for starting the program;
executing the first operating data, and displaying a first page of the program according to the first operating data;
determining, in response to a second triggering instruction of a control in the first page, a second page identifier corresponding to the control;
obtaining second operating data from the server according to the second page identifier if operating data corresponding to the second page identifier is not in the first operating data, the second operating data comprising the operating data corresponding to the second page identifier; and
executing the second operating data, and displaying a second page according to the second operating data, the second operating data comprising a plurality portions of the program.

14. The apparatus according to claim 13, wherein the processor executes the operating data corresponding to the second page identifier if the operating data corresponding to the second page identifier is in the first operating data, and displaying the second page according to the operating data corresponding to the second page identifier.

15. The apparatus according to claim 13, wherein the processor is further configured to:
transmit an obtaining request to the server, the obtaining request carrying an identifier of the program; and
receive the first operating data transmitted by the server in response to the obtaining request.

16. The apparatus according to claim 13, wherein the processor executes the first operating data by using an operating container; and
executes the second operating data by using the operating container.

17. The apparatus according to claim 16, further comprising:
a storage module storing the obtained first operating data in a local storage area;
the processor being further configured to obtain the first operating data in the local storage area, and transmit the first operating data to the operating container; and
execute the first operating data by using the operating container after the first operating data is transmitted to the operating container.

18. The apparatus according to claim 17, wherein the first operating data comprises first logical operating data and first view operating data corresponding to the first page; and
the processor is further configured to:
obtain the first logical operating data in the local storage area, and transmitting the first logical operating data to the operating container; and
obtain the first view operating data in the local storage area, and transmitting the first view operating data to the operating container after the operating container runs the first logical operating data, and then displaying the first page of the program.

19. The apparatus according to claim 13, the first operating data comprising page jump paths corresponding to a plurality of controls.

20. The apparatus according to claim 19, wherein the processor is further configured to:
determine a first page jump path according to the control and taking the first page jump path as the second page identifier.
